(19) United States
(12) Patent Application Publication
(10) Pub. No.: US 2024/0020642 A1
(43) Pub. Date: Jan. 18, 2024

(54) PATENT VALUATION USING ARTIFICIAL INTELLIGENCE

(71) Applicant: OLYMPUS CORPORATION, Tokyo (JP)

(72) Inventors: Yoshikazu AKAMINE, Uenohara-shi (JP); Ryo KARASAWA, Hachioji-shi (JP); Atsushi OKAWA, Hachioji-shi (JP)

(73) Assignee: OLYMPUS CORPORATION, Tokyo (JP)

(21) Appl. No.: 18/372,731

(22) Filed: Sep. 26, 2023

Related U.S. Application Data
(63) Continuation of application No. PCT/JP2022/016882, filed on Mar. 31, 2022.
(60) Provisional application No. 63/169,137, filed on Mar. 31, 2021.

(51) Int. Cl. G06Q 10/10; G06Q 50/18

(52) U.S. Cl. CPC G06Q 10/10; G06Q 50/184

(57) ABSTRACT

A system and method are provided for using artificial intelligence for patent valuation. The method includes obtaining a master list of patent classification codes used by a patent office. The method also includes, for each patent issued by the patent office: obtaining a respective set of patent classification codes assigned to the respective patent and forming a respective training vector. Each element in the respective training vector is a categorical variable that specifies whether a patent classification code is included in the respective set of classification codes. The system receives a respective user-specified value metric for each patent. The method also includes training a machine learning model according to a training data table that includes the training vectors. The machine learning model is configured to predict value metrics for patents according to their corresponding patent classification codes.

### CROSS-REFERENCE TO RELATED APPLICATIONS

The present application is a continuation application based on PCT Patent Application No. PCT/JP2022/016882, filed on Mar. 31, 2022, the entire content of which is hereby incorporated by reference.

### TECHNICAL FIELD

The disclosed implementations relate generally to valuation of patents, and more specifically to systems and methods, for patent valuation using artificial intelligence. This application claims the benefit of U.S. Provisional Application No. 63/169,137 filed 31 Mar. 2021, the entire disclosure of which is hereby incorporated by reference herein.

### BACKGROUND ART

Patents are valuable assets for companies worldwide. Mergers and acquisitions are frequently hinged on valuing patents, issued or pending. Even before a patent is published, or sometimes even before they are written, companies have a vested interest in estimating the value of patents, before investing sizable amounts of money to draft and prosecute patents. Conventional methods of valuing patents have relied on manual reviews. With the advent of machine learning, some techniques have emerged for automating patent valuation. But such traditional methods have relied on bibliographic entries of published patents as explanatory variables. Some techniques only process numeric data, such as number of claims, number of independent claims, number of characters in the claims, and so on, as explanatory variables. Some conventional methods use number of citations for valuing patents. However, since the number of citations requires a certain amount of time to become stable, it is not a reliable indication of the value of a recently filed patent. At the same time, the most valuable patents for strategic reasons include those that have just been applied for or have not yet been published. There are currently no known tools that can predict value metrics for patents, such as the number of citations, the citation score based on citation information including the number of citations, or the patent score calculated based on various indexes related to values of patents.

### SUMMARY OF INVENTION

In addition to the problems set forth in the background section, there are other reasons where an improved system and method of patent valuation using machine learning are needed. For example, there are machine learning-based techniques that use text data of the patent as explanatory variables to determine if a patent is necessary. But machine learning techniques that are performed after natural language processing of text result in poor classification accuracy. Even though recurrent neural networks are able to partially overcome such problems, deep learning typically requires a large amount of labeled data and substantial computing power.

The present disclosure describes a system and method that addresses some of the shortcomings of conventional methods and systems. The disclosure describes techniques for using patent classification codes (and other non-numeric data) in patent applications, to create a sparse matrix that is suitable for efficient machine learning. One or more machine learning models are trained to predict patent valuation based on user-provided metrics. For example, the system uses information on the presence or absence of patent classification codes assigned to other patents in a training dataset, to train the machine learning models. This information is encoded into a large sparse matrix, which is used for efficient training of the machine learning models trained to evaluate or predict the value of the patents. In this way, the techniques enable fast and accurate evaluation or prediction of patents with limited computing power and without the need for large amounts of labeled data.

In accordance with some implementations, a method for training a machine learning model for patent valuation executes at a computing system. Typically, the computing system includes a single computer or workstation, or plurality of computers, each having one or more CPU and/or GPU processors and memory. The method of machine learning modeling implemented does not generally require a computing cluster or supercomputer.

The method includes obtaining an ordered master list of n distinct patent classification codes c₁, c₂, . . . , cₙ used by a patent office to characterize patent subject matter. Note that this is not necessarily all of the classification codes used by the patent office. The method also includes performing a sequence of steps for each of a plurality of patents issued by the patent office. The sequence of steps includes obtaining a respective set of one or more patent classification codes assigned to the respective patent by the patent office. Each of the patent classification codes in the respective set matches a respective patent classification code in the master list. The sequence of steps also includes forming a respective training vector comprising n elements. The ith element in the respective training vector is a categorical variable that specifies whether the patent classification code cᵢ is included in the respective set of one or more classification codes. The sequence of steps also includes receiving a respective user-specified value metric for the respective patent. The method also includes generating a training data table comprising the training vectors, and training a machine learning model according to the training data table. The machine learning model is configured to predict value metrics for patents according to their corresponding patent classification codes.

In some implementations, the method further includes, for each of the plurality of patents issued by the patent office: extracting additional information from the respective patent, where the additional information includes non-numeric data; converting the non-numeric data in the respective patent to additional categorical variables; and generating the training data table further based on the additional categorical variables.

In some implementations, the additional information includes classification codes used by the patent office to search for prior art related to the respective patent.

In some implementations, the method further includes, after training the machine learning model: obtaining a new patent issued by the patent office; obtaining a new set of one or more patent classification codes assigned to the new patent by the patent office, where at least one patent classification code cₙ₊₁ in the new set does not match any patent classification code in the master list; updating each training vector in the training data table to include another element corresponding to the at least one patent classification code cₙ₊₁; updating the training data table to include a new training vector comprising n+1 elements for the new patent. The ith element in the new training vector is a categorical variable that specifies whether the patent classification code cᵢ is included in the new set of one or more classification codes; and retraining the machine learning model according to the updated training data table. In this way, when a new classification code that has not been used in the training data is found, the new classification code is added to the sequence in the training data, and patents with the new classification code are added to the training data.

In some implementations, the machine learning model is further configured to output a respective confidence level for each predicted value metric. The respective confidence value for a respective patent is based on a percentage of patent classification codes for the respective patent that are included in the training data table. In some implementations, to calculate the respective confidence level, the method uses information on the presence or absence (e.g., represented using binary values 1 and 0) of elements of categorical variables, such as patent classification codes and applicant names. It is equally important to have information that the element is present (1) as well as information that the element is absent (0). Therefore, if there is no information on either the presence or absence (1, 0), machine learning would not be able to make predictions accurately. However, some predictions will be made even though they are not accurate. In that case, the predicted value will be unreliable, because the prediction does not include a basis for the prediction. Although it is only a matter of comparison, it is still meaningful to compare the reliability or confidence level, by referring to the richness of the patent classification codes. In some implementations, the method evaluates the accuracy of the prediction results using metrics, such as R2 (sometimes called R-squared). Some implementations output particular bibliographic information that contributed to the accuracy of the prediction by referring to feature importance (e.g., Gini importance). In many cases, some bibliographic data of patents to be predicted is missing, but the importance and the degree of missing data can be used to evaluate the reliability.

In some implementations, the method further includes, in accordance with a determination that the respective confidence level is below a minimum confidence level threshold: obtaining a new patent issued by the patent office and obtaining a new set of one or more patent classification codes assigned to the new patent by the patent office. At least one patent classification code cₙ₊₁ in the new set does not match any patent classification codes in the master list. The method extends the master list to incorporate the one or more patent classification codes assigned to the new patent, including the at least one patent classification code cₙ₊₁; updates each training vector in the training data table to include another element corresponding to the at least one patent classification code cₙ₊₁; updates the training data table to include a new training vector comprising n+1 elements for the new patent, where the ith element in the new training vector is a categorical variable that specifies whether the patent classification code cᵢ is included in the new set of one or more classification codes; and retrains the machine learning model according to the updated training data table.

In some implementations, the machine learning model includes one or more of: Support Vector Regression, Light Gradient Boosted Machine regression, Random forest regression, Binary or multi-valued classifiers, and Deep neural networks.

In some implementations, the master list of patent classification codes is extracted from the plurality of patents.

In another aspect, a method is provided for using machine learning for patent valuation, and the method executes at a computing system. Typically, the computing system includes a single computer or workstation, or plurality of computers, each having one or more CPU and/or GPU processors and memory. The method of using machine learning does not generally require a computing cluster or supercomputer. The method also includes obtaining an ordered master list of n distinct patent classification codes c₁, c₂, . . . , cₙ used by a patent office to characterize patent subject matter. The method also includes obtaining a patent that requires valuation. The method also includes obtaining a set of one or more patent classification codes for the patent. One or more of the patent classification codes in the set match a respective patent classification code in the master list. The method also includes forming an input vector comprising n elements. The ith element in the input vector is a categorical variable that specifies whether the patent classification code cᵢ is included in the set of one or more classification codes. The method also includes predicting and outputting a value metric for the patent according to a trained machine learning model that has been trained to predict value metrics for patents according to their respective patent classification codes and user-supplied value metrics.

In some implementations, the method further includes extracting additional information from the patent, where the additional information includes non-numeric data. Forming the input vector further includes converting the non-numeric data in the patent to additional categorical variables, and including the additional categorical variables in the input vector.

In some implementations, the method further includes, in accordance with a determination that the patent is an unpublished patent that lacks patent classification codes: estimating the set of one or more patent classification codes for the patent based on one or more attributes of the patent, such as inventor information, applicant information, and subsidiary information.

In some implementations, the trained machine learning model includes one or more of: Support Vector Regression; Light Gradient Boosted Machine regression; Random forest regression; Binary or multi-valued classifiers; and Deep neural networks.

In some implementations, the master list of patent classifications and the trained machine learning model are compressed and stored in a compressed file. The method further includes decompressing the compressed file to retrieve the trained machine learning model and the master list of patent classifications.

In some implementations, the master list of patent classifications and the trained machine learning model are serialized into one or more byte streams. The method further includes deserializing the one or more byte streams to retrieve the master list of patent classifications and the trained machine learning model.

In some implementations, a computing system includes one or more computers. Each of the computers includes one or more processors and memory. The memory stores one or more programs that are configured for execution by the one or more processors. The one or more programs include instructions for performing any of the methods described herein.

In some implementations, a non-transitory computer readable storage medium stores one or more programs configured for execution by a computing system having one or more computers, each computer having one or more processors and memory. The one or more programs include instructions for performing any of the methods described herein.

In another aspect, a method is provided for training a machine learning model for patent valuation. The method includes obtaining a list of patent applications for training the machine learning model. The method also includes: for each of a plurality of patent applications in the list of patent applications: vectorizing a respective set of text strings for the respective patent application to form a training vector consisting of m dimensions using natural language processing. Each element in the training vector is a numerical value representing one of m distinct textual features of the text strings; and receiving a respective user-specified value metric for the respective patent. The method also includes generating a training data table comprising the training vectors, and training the machine learning model according to the training data table, the machine learning model configured to predict value metrics for patent applications according to the numerical values of textual features.

In some implementations, the method further includes for each of the plurality of patent applications: extracting additional information from the respective patent application. The additional information includes numeric data and non-numeric data; converting the non-numeric data in the respective patent to categorical variables; and generating the training data table further based on the numeric data and the categorical variables.

In some implementations, the additional information includes classification codes used by a patent office to search for prior art related to the respective patent application.

In some implementations, the additional information includes bibliographic data for the respective patent application.

In some implementations, the method further includes, after training the machine learning model: obtaining a new patent application; vectorizing a respective set of text strings for the new patent application to form a training vector consisting of m dimensions using natural language processing. Each element in the training vector is a numerical value representing one of m distinct textual features of the text strings; receiving a new user-specified value metric for the new patent application; updating the training data table to include the training vector; and retraining the machine learning model according to the updated training data table.

In some implementations, the machine learning model includes one or more models selected from the group consisting of: Support Vector Regression; Light Gradient Boosted Machine regression; Random forest regression; Binary or multi-valued classifiers; and Deep neural networks.

In another aspect, a method is provided for using machine learning for patent valuation. The method includes obtaining a patent application that requires valuation; obtaining a set of text strings for the patent application; vectorizing the set of the text strings for the patent application into an input vector consisting of m dimensions using natural language processing. Each element in the input vector is a numerical value representing one of m distinct textual features of the text strings; and predicting and outputting a value metric for the patent application according to a trained machine learning model that has been trained to predict value metrics for patent applications according to numerical values of textual features and user-supplied value metrics.

In some implementations, the method further includes: extracting additional information from the patent application. The additional information includes numeric data and non-numeric data. Forming the input vector further includes converting the non-numeric data in the patent application to categorical variables, and including the numeric data and the categorical variables in the input vector.

In some implementations, the additional information includes classification codes used by the patent office to search for prior art related to the patent application.

In some implementations, the additional information includes bibliographic data for the patent application.

In some implementations, the trained machine learning model includes one or more models selected from the group consisting of: Support Vector Regression; Light Gradient Boosted Machine regression; Random forest regression; Binary or multi-valued classifiers; and Deep neural networks.

In another aspect, a system is provided for patent valuation using machine learning. The system includes a database storing targeted patent data records used for training, testing, and/or validation of one or more machine learning models. The system also includes a training data extraction module for extracting data for training a machine learning model from the targeted patent data records. The extracted data includes one or more objective variables to predict value of patent applications. The system also includes a patent text data extraction module for extracting text data contained in documents for patent applications. The system also includes a training data generation module for generating training data for training one or more machine learning models. The training data generation module forms training vectors by converting the text data into a vector using natural language processing. The system also includes a module to train one or more machine learning models using the training data generated by the training data generation module. The system also includes a test data extraction module, which extracts test data from the targeted patent data records. The system also includes a patent text data extraction module, which extracts text data from patent applications in the test data extracted by the test data extraction module. The system also includes a test vector generation module for generating test vectors based on the text data extracted by the patent text data extraction module. The system also includes a module for predicting and outputting a value metric for a patent application using the test vectors according to a trained machine learning model.

Thus methods and systems are disclosed that facilitate patent valuation using artificial intelligence.

### BRIEF DESCRIPTION OF DRAWINGS

For a better understanding of the disclosed systems and methods, as well as additional systems and methods, reference should be made to the Description of Implementations below, in conjunction with the following drawings in which like reference numerals refer to corresponding parts throughout the figures.

FIG. 1 shows a block diagram of a system for patent valuation using machine learning, and example output data predicted by the system, in accordance with some implementations.

FIG. 2A shows examples of training data and test data extracted from patent records, in accordance with some implementations.

FIG. 2B shows example training data tables, in accordance with some implementations.

FIG. 2C shows examples of training data and test data extracted from patent records, in accordance with some implementations.

FIG. 2D shows example training data tables, in accordance with some implementations.

FIG. 2E shows an example of input data that includes unpublished patents, according to some implementations.

FIG. 3 is a block diagram of a computing device according to some implementations.

FIG. 4A is a block diagram of an alternative of the system shown in FIG. 1, according to some implementations.

FIG. 4B is a block diagram of another alternative of the system shown in FIG. 1, according to some implementations.

FIG. 5 is a flow diagram of an example process for patent valuation, according to some implementations.

FIG. 6 shows a block diagram of an alternate system for patent valuation using machine learning when patent classification codes have not been assigned to patents, and example output data predicted by the system, in accordance with some implementations.

FIG. 7 shows a flowchart of a method for training a machine learning model for patent valuation, according to some implementations.

FIG. 8 shows an example input data table, according to some implementations.

FIG. 9 shows an example vectorized data table for the example input data table shown in FIG. 8, according to some implementations.

FIG. 10 shows an example input data table, according to some implementations.

FIG. 11 shows an example vectorized data table for the example input data table shown in FIG. 10, according to some implementations.

FIG. 12 shows an example input data table, according to some implementations.

FIG. 13 shows an example vectorized data table for the example input data table shown in FIG. 12, according to some implementations.

FIG. 14 shows an example input data table, according to some implementations.

FIG. 15 shows an example vectorized data table for the example input data table shown in FIG. 14, according to some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF EMBODIMENTS

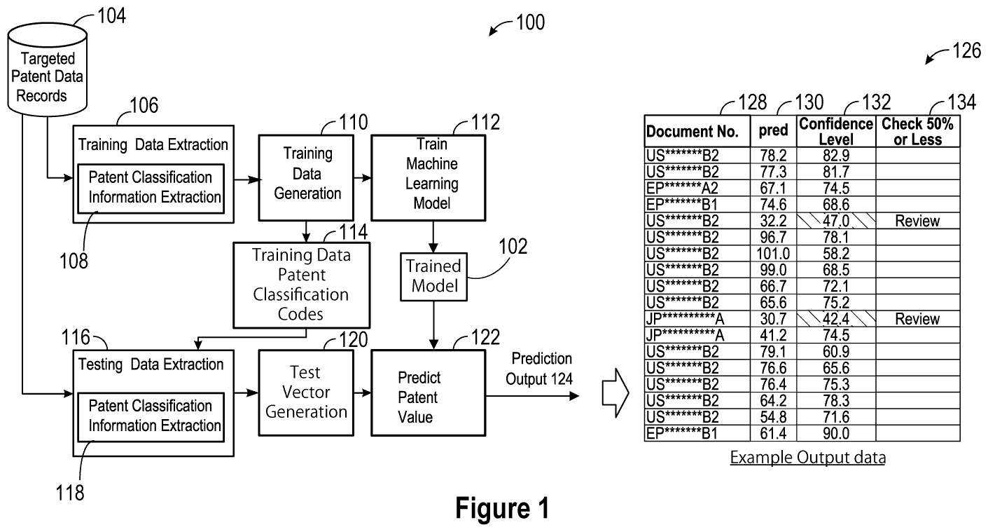

FIG. 1 is a diagram of a system 100 for patent valuation using machine learning, in accordance with some implementations. FIG. 1 also shows an example output data 126 predicted by the system 100, according to some implementations. Targeted patent data records 104 store patents used for training, testing, and/or validation of one or more machine learning models. For example, the records 104 include patents issued by a patent office. In some implementations, the records 104 includes the entirety or portions of patents pending, utility models, design patents, and/or new applications. The system 100 includes a training data extraction module 106 for extracting data (e.g., preparing data for training a machine learning model) from the records 104. For example, the module 106 includes steps for selecting patents for training a machine learning model, and/or extracting specific information (e.g., numeric data or non-numeric data) from patents in the records 104.

In some implementations, the module 106 also obtains a list of patent classification codes used by a patent office to characterize patent subject matter. In some implementations, the list is an ordered master list of n distinct patent classification codes c₁, c₂, . . . , cₙ used by the patent office to characterize patent subject matter. In some implementations, the list includes patent classification codes of different types, such as IPC and CPC.

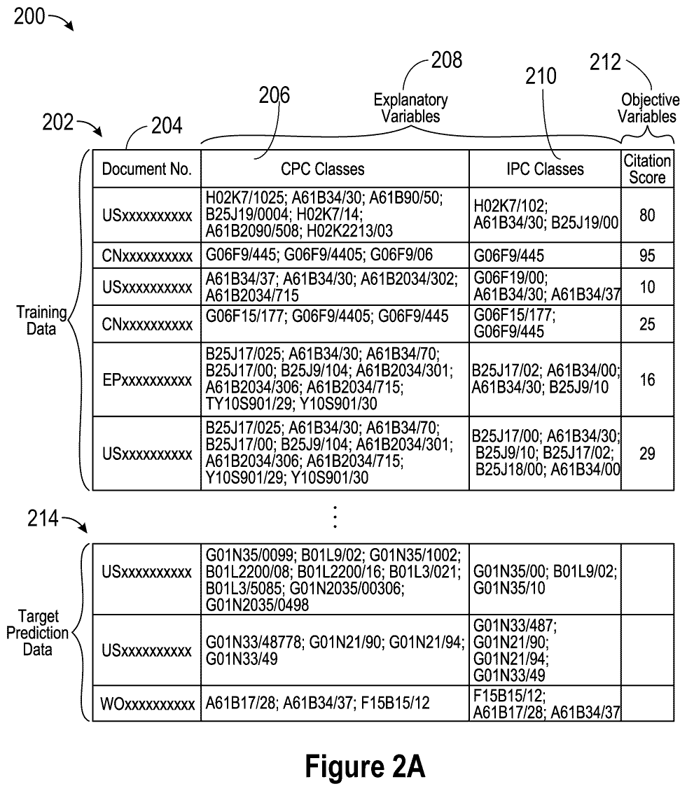

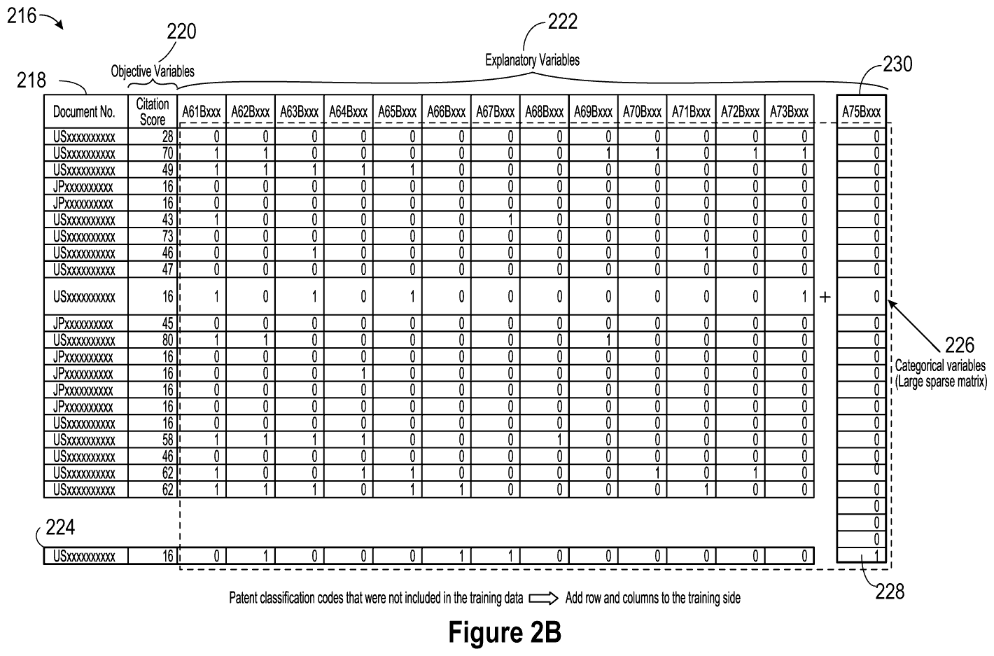

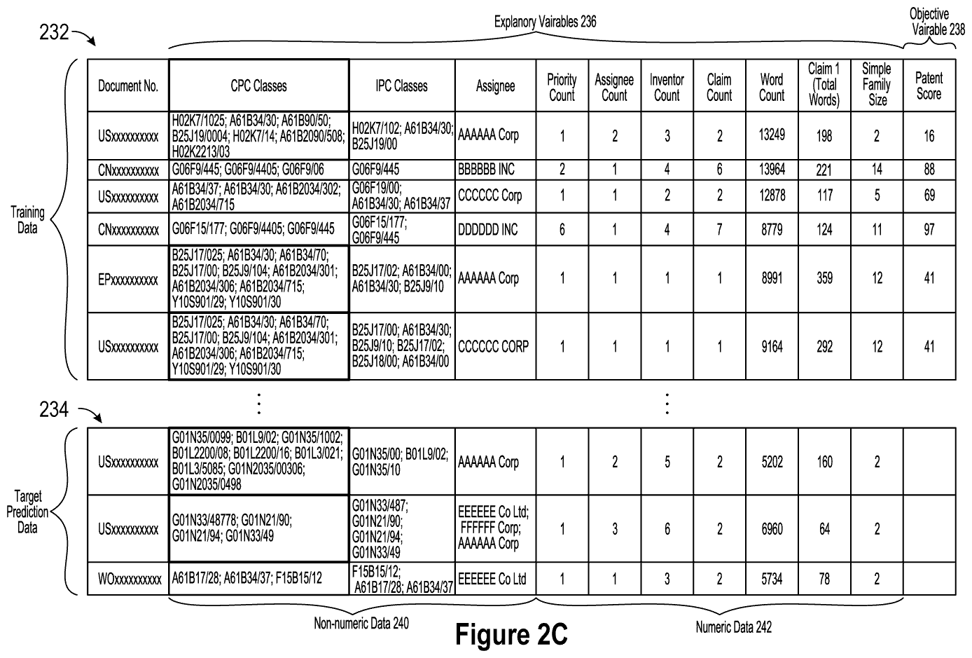

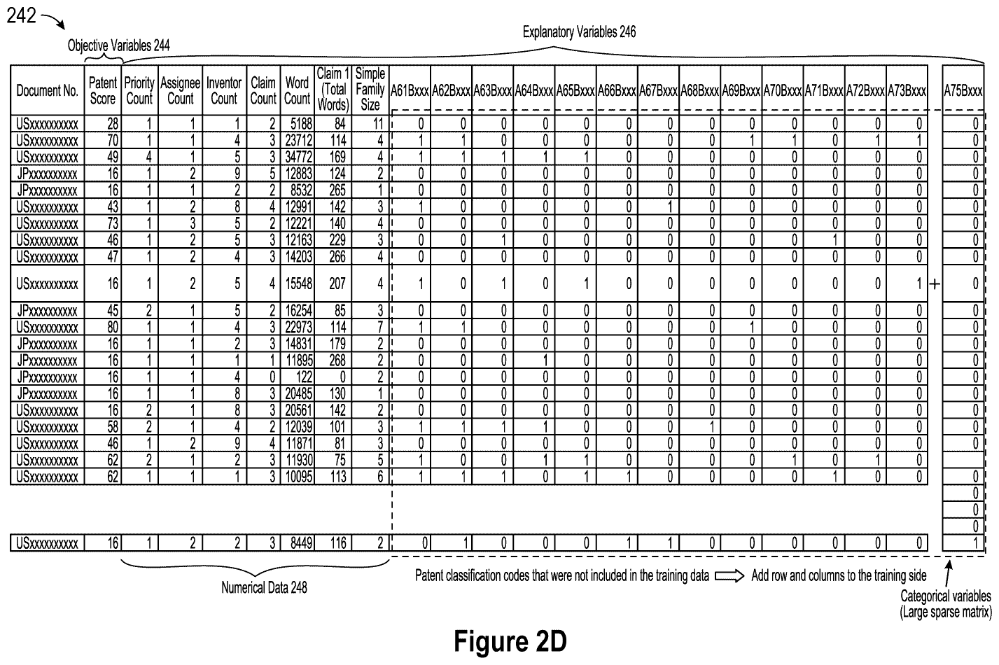

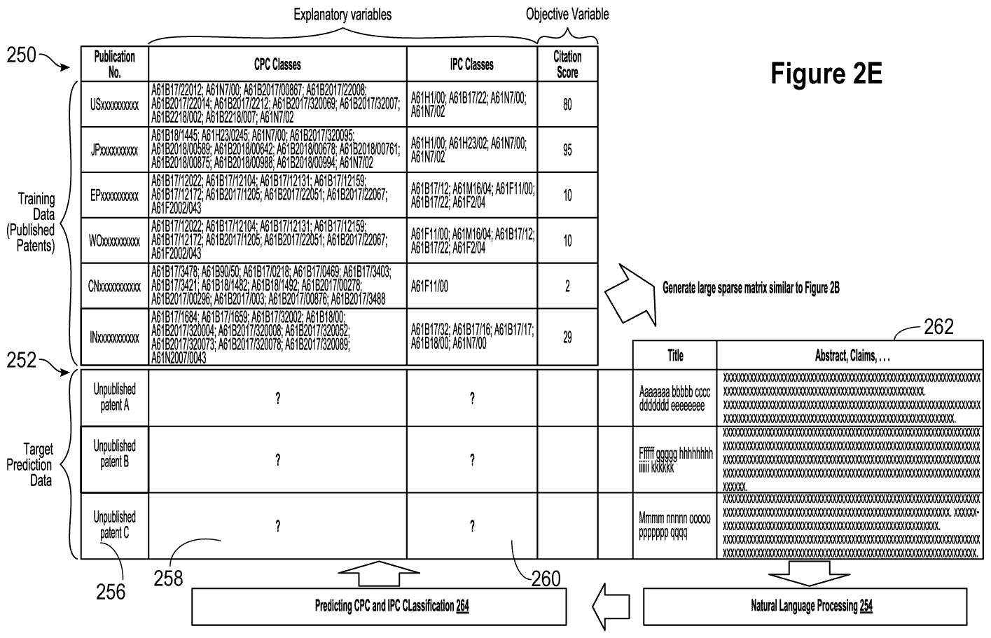

In some implementations, the module 106 is also configured to extract additional information from the respective patent, such as numeric data and/or non-numeric data. In some implementations, the module 106 is also configured to convert the non-numeric data in the respective patent to additional categorical variables (in addition to the categorical variables obtained from patent classification codes described below). The non-numeric information includes, for example, CPC, IPC, IPC8, F-term (assigned by Japan Patent Office), FI (assigned by Japan Patent Office), applicant name, and inventor name. Numeric information includes, for example, number of families, number of words of specification, number of words of claim 1, number of claims, number of inventors, number of assignees, and number of claimed priority. These examples are described below in reference to FIGS. 2A-2D, according to some implementations.

The system 100 also includes a patent classification extraction module 108, which extracts patent classification codes from a given patent (e.g., one of the patents in the records 104). Examples of patent classification codes are described below in reference to FIGS. 2A-2D, according to some implementations. In some implementations, the patent classification extraction module 108 obtains a respective set of one or more patent classification codes assigned to a respective patent by the patent office. Each of the patent classification codes in the respective set matches a respective patent classification code in the master list described earlier.

The system 100 also includes a training data generation module 110 for generating training data for training one or more machine learning models. In some implementations, the module 110 forms training vectors. In some implementations, each training vector corresponds to a respective patent issued by the patent office. In some implementations, each training vector includes n elements, where i-th element in the training vector is a categorical variable that specifies whether the patent classification code cᵢ is included in the respective set of one or more patent classification code described earlier. In some implementations, a set of categorical variables included as elements of the training vector is a set of binary values. The set of binary values represents whether or not each patent classification code assigned to any patent is selected for training by the module 106. In other words, the set of categorical variables includes any patent classification code that appears at least once in the training data. Each patent in the training data is assigned a binary value depending on whether a patent classification code is assigned to the patent. For example, if a patent classification code ci which is assigned to Patent X is not assigned to another Patent Y in the data extracted by the module 106, the binary value of a patent classification code ci for Patent Y will be “0.” In some implementations, training data is at least a set of patent classification codes and it may additionally include other non-numerical data and numerical data, examples of which are described below in reference to FIGS. 2A-2D, In some implementations, the training data generation module 110 also generates training vectors based on additional categorical variables from the respective patent. For example, the additional categorical variables include corresponding binary values for patent classification codes that are searched during prior art search for a patent.

In some implementations, as described below in reference to FIGS. 2A-2D, data extracted by the module 106 may include an objective variable that is relevant to value of patents (e.g., citation score, patent score). The data extracted may be retrieved from a patent database or provided by a user. A value metric is selected from numeric data out of the extracted data, and may represent value of patents. The selected value metric is treated as an objective variable in training a machine learning model. After the training process, the system 100 uses the objective variable to predict value of patents.

In some implementations, the module 110 also receives a user-specified value metric for a patent. For example, a user may provide (or assign) a particular value for a patent (or a group of patents) and/or patent classification codes. To further illustrate, the user may statically assign a first value (e.g., a high value) for one type of patents (e.g., pharmaceutical patents) and a second value (e.g., a low value) for another type of patents (e.g., business method patents). In this way, the user provides labels for different patents (as is commonly the case in supervised learning systems). In some implementations, the module 110 also generates a training data table (an example of which is shown in FIG. 2B, and described below), which includes the training vector, according to some implementations.

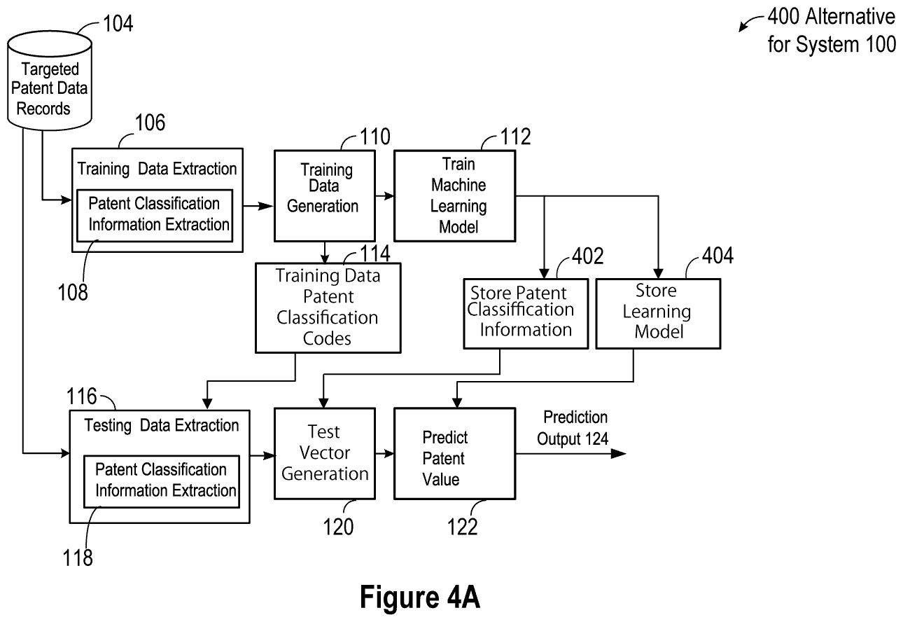

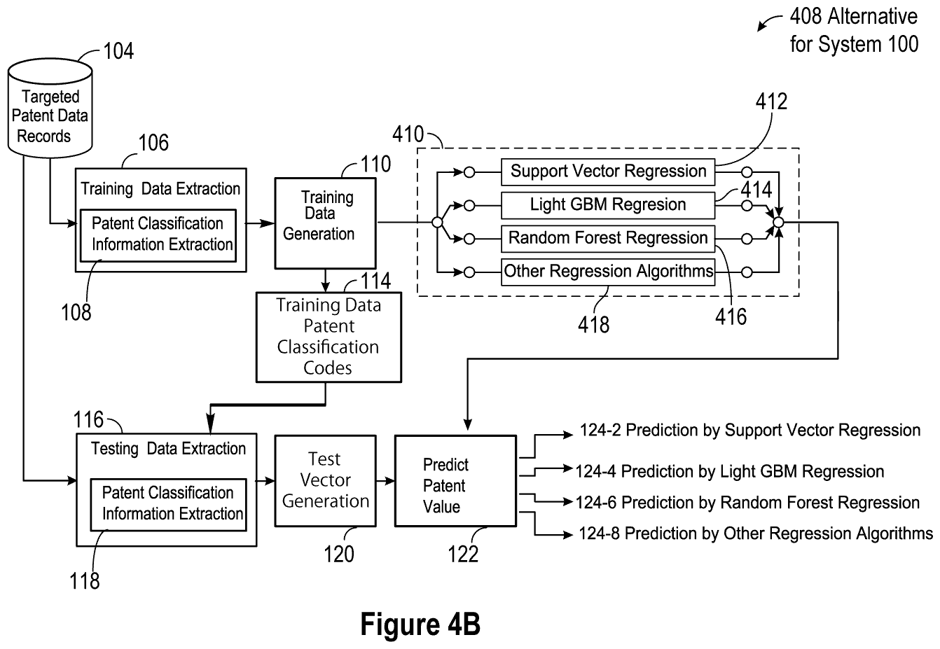

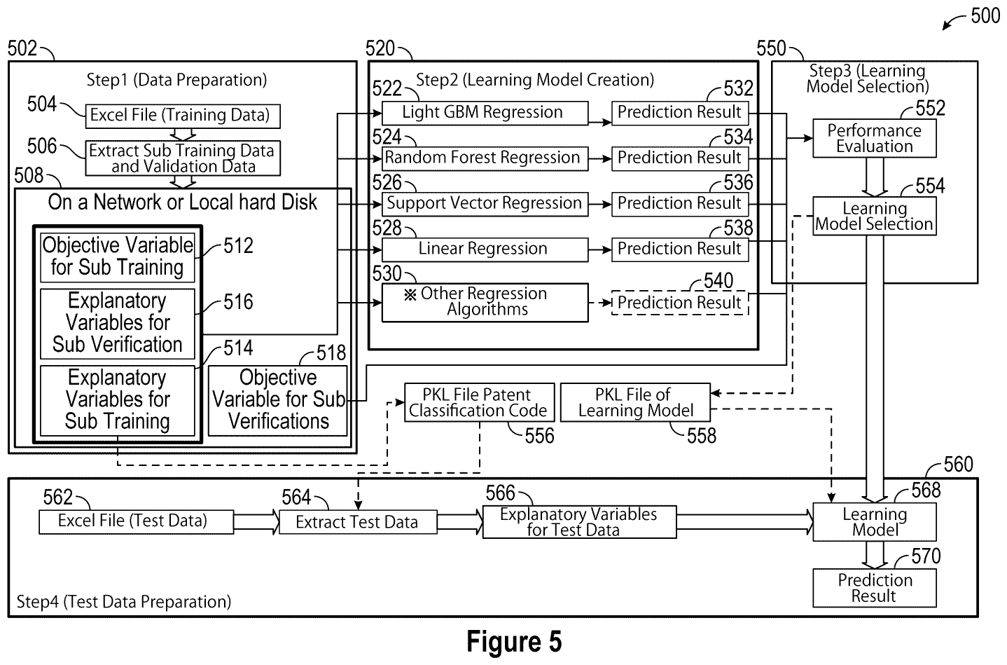

The system also includes a module 112 to train one or more machine learning models 102 using the training data generated by the module 110. Examples of machine learning models are described below in reference to FIGS. 4B and 5, according to some implementations. The one or more machine learning models 102 are configured to predict value metrics for patents according to at least their patent classification codes. For example, the machine learning model 102 is trained to predict that a new patent that has a patent classification code that corresponds to the pharmaceutical industry has a higher value than a patent for a business method.

The block diagram in FIG. 1 shows both training and testing aspects of the system 100, according to some implementations. For testing (or using) the system 100 for predicting value of patents, the system 100 includes a test data (or input data) extraction module 116. The operations of the test data extraction module 116 are similar to the training data extraction module, except that the module 116 uses test data from the targeted patent data records 104. In some implementations, the patents in the records 104 are statically partitioned into training data and test data (e.g., 80% of the patents are placed in the training dataset and the remaining are placed in the test dataset). In some implementations, the module 116 obtains a new patent issued by the patent office. In some implementations, the module 116 obtains a patent that requires valuation. Similar to the module 108, a patent classification information extraction module 118 extracts patent classification codes from patents in the test data extracted by the test data extraction module 116. For this step, the module 118 cross-references the patent classification codes 114 in the training data table, according to some implementations. Since the machine learning models 102 are trained to predict value only for the patents with some patent classification codes in the training dataset, the module 118 only looks for known patent classification codes, according to some implementations. Supposing a new patent has a patent classification code that is not in the known set of codes 114, some implementations add the new patent classification codes to the training data table generated by the training data generation module 110 and retrain the trained machine learning module 102. These details are further described below in reference to FIG. 2B, according to some implementations. The system 100 also includes a test vector generation module 120 for generating test vectors (sometimes called an input vector) based on the patent classification codes extracted by the module 118, and/or the training data patent classification codes 114. In some implementations, the input vector includes n elements. The ith element in the input vector is a categorical variable that specifies whether the patent classification code cᵢ is includes in the set of one or more classification codes (e.g., codes assigned by the patent office).

The system 100 also includes a module 122 for predicting and/or outputting a value metric 124 (sometimes called prediction output) for a patent according to a trained machine learning model (e.g., the one or more machine learning models 102), which has been trained to predict value metrics for patents according to their respective patent classification codes and user-supplied value metrics. To use the system 100 for predicting value of patents, the path shown for testing the system 100 (e.g., steps performed by the module 114, the module 116, the module 118, the module 120, and/or the module 122) is used, according to some implementations.

FIG. 1 also shows a table 126 that includes value predictions 130 for patent documents (indicated by different document numbers 128), according to some implementations. In some implementations, the system 100 outputs individual prediction output 124 for each patent (e.g., a new patent issued by the patent office, or a new unpublished patent). In some implementations, the system 100 outputs a batch (e.g., a table) of prediction outputs similar to the example shown in FIG. 1. In some implementations, the system 100 also outputs a confidence level 132 for predicted value of patents. In some implementations, the machine learning model is further configured to output a respective confidence level for each predicted value metric (when there are two or more value metrics). In some implementations, the respective confidence value for a respective patent is based on a percentage of patent classification codes for the respective patent that are included in the training data table.

In some implementations, the system 100 also outputs data (shown in column 134) as to whether a concerned patent should be reviewed by a user for validating the predicted output 124 for the patent, to add any missing patent classification codes to the table generated by the module 110, and/or to retrain the machine learning models 102, for improving its accuracy and/or prediction quality. For example, if the confidence level 132 is below a threshold (e.g., 50%), then the patents (or patent applications) are marked for further analysis and/or inclusion in the training data table, and/or the machine learning models 102 are retrained using the updated training data table. As shown in FIG. 2A, some patents may have patent classification codes (e.g., classification code 236) that are not recognized by the machine learning model 102, are not present in the training data table generated by the module 110, or are just incorrect codes. In any case, the system may reference the training data table patent classification codes 114 (or the master list described above) to determine that the code needs to be added to the training data table, that the machine learning model 102 needs to be retrained, and/or an appropriate user message has to be generated to indicate the situation.

FIG. 2A shows examples 200 of training data 202 and test data 214 (sometimes called target prediction data) extracted from the patent records 104, according to some implementations. Although the examples show the data organized in the form of a table, the system 100 may use any format to collect, organize, and/or extract this data from the patent records 104. In the example, column 204 includes patent application numbers (this may be just an identifier for unpublished patents) for patents and may include application numbers assigned by various patent offices. In the examples shown, applications with prefix US refer to applications originating in the United States, applications with prefix CN refer to applications originating in China, applications with prefix EP refer to applications originating in the European Union, applications with prefix WO are PCT applications, and applications with JP prefix are applications originating in Japan. It should be understood that the patent records 104 may contain patent applications from multiple jurisdictions, patents issued by different patent offices, and so on. Column 206 refers to patent classification codes for patents (sometimes called CPC). Each patent may be assigned one or more patent classification codes. The training data 202 and the target prediction data 214 include explanatory variables 208 and objective variables 212. The explanatory variables 208 in turn includes CPC classes 206 and IPC (international patent classification) classes 210, according to some implementations. The objective variables 212 include citation scores, according to some implementations. The portion 214 refers to target prediction data or example patents for which valuation is required. In some instances, there are one or more patent classification codes (e.g., CPC or IPC classes) that are not in the trained model 102, so such classification codes are not used in value prediction.

FIG. 2B shows an example training data table 216 generated by the module 110, according to some implementations. Column 218 correspond to the document numbers 204, column 220 includes objective variables (e.g., the citation scores 212), and columns 222 correspond to explanatory variables (e.g., the patent classification codes 206 and 210). The patent classification codes (e.g., codes obtained from the record 104) are arranged as columns of the table 216, and each row corresponds to a specific patent application. Some implementations include the application number (e.g., column 218) when training the machine learning model 102. Some implementations encode or add the user value metric as another column (not shown). Each of the columns 222 corresponds to a respective patent classification code. If a patent application has (or an unpublished patent is estimated to have) a patent classification code, then the column for that patent application is marked by a value of 1, and the absence of the code is indicated by a value of 0. It is noted that, although the examples here show just the patent classification codes in the patent application, other non-numeric data in the patent applications or unpublished patents can be converted to categorical variables (not just binary valued variables; this can be variables with multiple categories). In any case, the table typically includes a majority of 0s and a few non-zero cells or values. Thus, the table is a large sparse matrix 226 which is especially suitable for efficient machine learning because the sparse matrix helps reduce processing time for evaluation or prediction of value of patents, even with limited computing power. In this way, sparse matrix computations can be applied for efficient prediction of patent values.

In some implementations, the module 110 determines that the patent corresponds to an unpublished patent that lacks patent classification codes, and receives user input regarding patent classification codes (e.g., IPC, CPC, FI, or F-term codes) for the patent.

FIG. 2B also shows a new patent application 224 that is added to the training data table 216. The patent application 224 includes a new patent classification code. (When the system 100 sees a new patent classification code for the first time, in some implementations, the system updates the training data table 216 with a new column 230 corresponding to the new patent classification code and initializes the column with a value of 0 for all patents that did not include that code, and a value of 1 otherwise. For example, cell 228 of the sparse matrix 228 has a value 1. In some implementations, even though some patents included the code, it was simply ignored before (e.g., because it was not in the master list). But when the new patent classification code is added (e.g., to improve accuracy, a user marks the code to be important, or the system automatically determines the code to be an important new addition for improving accuracy), the rows for previous patent applications that included the code are also updated to indicate a value of 1 (i.e., the presence of the code), examples of which are shown by cells 238 in FIG. 2B. Some implementations generate a new vector 234 for the patent, which includes a value of 0 for previously known patent classification codes (e.g., following the order in the master list), and a value of 1 for newly seen patent classification codes. In this way, the system 100 can continuously evolve to improve accuracy of predictions, add new data, and retrain based on newly available patent classification and/or patent information, according to some implementations.

FIG. 2C shows example training data 232 and target prediction data 234, each including explanatory variables 236 and an objective variable 238. The explanatory variables 236 include CPC classes, IPC classes, assignee, priority count, assignee count, inventor count, claim count, word count, total words in claim 1, family size, and the objective variable 238 includes a patent score. The CPC classes, IPC classes, and assignee, are example of non-numeric data 240, and the rest are examples of non-numeric data 242. FIG. 2D shows an example training data table 242 generated by the module 110 for the example shown in FIG. 2C, according to some implementations. Similar to the training data table shown in FIG. 2B, in FIG. 2D, column 244 includes objective variables (e.g., the patent score 238), and columns 246 correspond to explanatory variables. Similar to FIG. 2B, the patent classification codes (e.g., codes obtained from the record 104) are arranged as columns of the table 242, and each row corresponds to a specific patent application. In addition to the non-numeric data that includes the patent classification codes, the table also includes columns for numeric data 248 corresponding to the numeric data 242 of FIG. 2C, including priority count, assignee count, inventor count, claim count, word count, total words in claim 1, and family size.

FIG. 2E shows example input data that includes unpublished patents, according to some implementations. In the example shown, the training data 250 includes published patents (as indicated by publication numbers), patent classification codes (explanatory variables that includes CPC classes and IPC classes), and an objective variable that includes citation scores. The target prediction data 252, on the other hand, includes unpublished patents 256, without patent classification codes (indicated by the question marks 258 and 260). For unpublished patents, in some implementations, the module 110 receives patent classification codes and an objective variable (e.g., as user input). In some implementations, the module 110 also receives text data 262 (e.g., abstracts or claims). The module 110 performs natural language processing 254 on the text data 262 to predict patent classification codes 264, according to some implementations. The predicted patent classification codes 264 for the unpublished patents 256, and patent classification codes for published patents, are used for training one or more machine learning models.

As described above, the techniques described herein use patent classification cods for evaluating and/or predicting the value of a patent by regression. Patent classification codes have a deep hierarchical structure that can classify detailed technologies and can assign many types of technological classifications to each patent. The techniques described herein transform the patent classification codes into categorical variables, which are then transformed into a large sparse matrix with mostly zero-valued cells or elements. For example, when patent classification codes (e.g., CPC or F-term codes) that have a deep hierarchy and that are often assigned to many individual patents, a large sparse matrix is obtained. Since patent classifications are assigned by a Patent Office, a certain level of classification quality is guaranteed. Therefore, by using the patent classification codes as input data for categorical variables, the system described herein obtains high quality large scale sparse matrices for training purposes. This allows the system to obtain regression and classification results with small amounts of data, minimal computing power, and faster prediction accuracy, compared to conventional deep learning techniques.

Some implementations add other information (e.g., numbers and table data obtained using natural language processing) to further improve the accuracy. For example, some implementations extract n-grams, using natural language processing, based on textual information (e.g., abstracts and claims) in patent gazettes, and generate vectors (e.g., a vector of 1s and 0s, with a value of 1 if the patent to be processed contains the n-grams, and 0 if the patent does not contain the n-grams). The result of the classification is used as a categorical variable. Some implementations consolidate a plurality of such results to compute a categorical variable, and use the variable as an explanatory variable for training purposes.

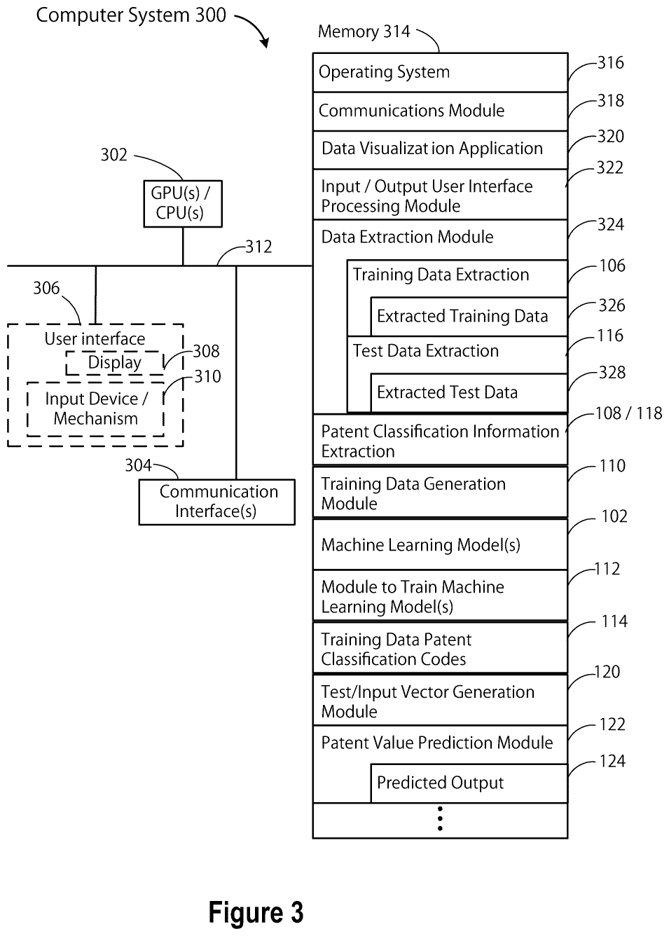

FIG. 3 is a block diagram illustrating a computing device 300 in accordance with some implementations. The system 100 described above in reference to FIGS. 1, 2A, 2B, and below in reference to FIGS. 4A, 4B, and 5, may be implemented using the computer system 300, according to some implementations. Various examples of the computing device 300 include high-performance clusters (HPC) of servers, supercomputers, desktop computers, cloud servers, and other computing devices. The computing device 300 typically includes one or more processing units/cores (CPUs and/or GPUs) 302 for executing modules, programs, and/or instructions stored in the memory 314 and thereby performing processing operations; one or more network or other communications interfaces 304; memory 314; and one or more communication buses 312 for interconnecting these components. The communication buses 312 may include circuitry that interconnects and controls communications between system components.

The computing device 300 may include a user interface 306 comprising a display device 308 and one or more input devices or mechanisms 310. In some implementations, the input device/mechanism includes a keyboard. In some implementations, the input device/mechanism includes a “soft” keyboard, which is displayed as needed on the display device 308, enabling a user to “press keys” that appear on the display 308. In some implementations, the display 308 and input device/mechanism 310 comprise a touch screen display (also called a touch sensitive display).

In some implementations, the memory 314 includes high-speed random access memory, such as DRAM, SRAM, DDR RAM or other random access solid state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the GPU(s)/CPU(s) 302. The memory 314, or alternatively the non-volatile memory devices within the memory 314, comprises a non-transitory computer readable storage medium. In some implementations, the memory 314, or the computer-readable storage medium of the memory 314, stores the following programs, modules, and data structures, or a subset thereof:
an operating system 316, which includes procedures for handling various basic system services and for performing hardware dependent tasks;
a communications module 318, which is used for connecting the computing device 300 to other computers and devices via the one or more communication network interfaces 304 (wired or wireless) and one or more communication networks, such as the Internet, other wide area networks, local area networks, metropolitan area networks, and so on;
an optional data visualization application or module 320 for displaying visualizations of patent value metrics;
an input/output user interface processing module 322, which allows a user to specify parameters or control variables;
a data extraction module 324, which includes the training data extraction module 106 and/or test data extraction module 116. In some implementations, the module 106 includes extracted training data 326 and the test data extraction module 116 includes extracted test data 328. In some implementations, the training data extraction 106 and test data extraction 116 are implemented using a single module;
the patent classification information modules 108 or 118 described above;
the training data generation module 110;
one or more machine learning models 102;
the module 112 to train machine learning model(s);
training data patent classification codes 114;
the test and/or input vector generation module 120; and/or
the patent value generation module 122 to predict and output the predicted output 124, described above in reference to FIG. 1.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 314 stores a subset of the modules and data structures identified above. Furthermore, the memory 314 may store additional modules or data structures not described above. The operations of each of the modules and properties of the data structures shown in FIG. 3 are further described below, according to some implementations.

Although FIG. 3 shows a computing device 300, FIG. 3 is intended more as a functional description of the various features that may be present rather than as a structural schematic of the implementations described herein. In practice, and as recognized by those of ordinary skill in the art, items shown separately could be combined and some items could be separated.

In some implementations, the memory 314 also includes modules to train and execute models 102. In some implementations, machine learning algorithms used for creating the one or more machine learning models 102 include LightGBM regression, Random Forest Regression, Support Vector Regression, Linear Regression, Neural Networks, Deep Learning, and/or other regression algorithms.

FIG. 4A is a block diagram of an alternative 400 for the system 100, which includes memory-related optimizations, according to some implementations. In some implementations, subsequent to training (112) the machine learning model, the system stores (404) the trained machine learning models 102 and/or stores (402) patent classification information extracted by the patent classification information extraction module 108 (e.g., the training data patent classification codes 114), in the memory 314. In some implementations, the trained machine learning models 102 are stored along with the list of patent classification codes (sometimes called the master list). These aspects are also described above in reference to FIGS. 2A-2E, according to some implementations. The training data generation module 110 converts the non-numeric data into a large sparse matrix used by the training module 112. The numeric data is input directly into the module 112. Subsequently, a machine learning model (e.g., the trained model 102) is generated and stored with the master list of patent classifications generated by the module 110 in a compressed or uncompressed state.

In some implementations, the trained machine learning models 102 are compressed column-wise along with the master list of patent classification codes, before storing the same in the memory 314. For example, the system 100 compresses the data of the machine learning model and the master list of patent classifications (e.g., using two PKL files), into a single compressed file (e.g., one Zip file). An advantage for compressing the data in this manner is that the training model and the master list of patent classifications are stored as a single unit, facilitating data management and reducing cost of memory.

In some implementations, the master list of patent classifications and/or the trained machine learning models 102 are serialized into one or more byte streams. The system 400 includes one or more modules in the memory 314 used to decompress any compressed data, and/or for deserializing any byte streams, to retrieve the master list of patent classifications and/or the trained machine learning model. Storing the patent classification codes from the training data enables efficient mapping of new patent classification codes, in formulating training and/or input vectors, and targeting patent valuation (for the selected codes). Compressing the data has the obvious advantage of reducing storage costs, for moving data (e.g., to customer sites), as well as efficient data management. Serializing data enables data portability, and enables the system 400 and/or the associated data to be used across computing platforms.

FIG. 4B is a block diagram of another alternative 408 of the system 100, according to some implementations. Some implementations train one or more machine learning models 410 (e.g., Support Vector Regression 412, Light GBM Regression 414, Random Forest Regression 416, or other regression algorithms 418) for the purpose of predicting patent value. Some implementations use the models 410 for predicting (122) patent value. Each of the trained machine learning models is used to predict output shown as output 124-2, 124-4, 124-6, and 124-8, according to some implementations. Depending on the level of accuracy of the predicted output, some implementations use a specific model chosen from one of the models described above, for future predictions.

Conventional regression typically uses a population where the explanatory and objective variables are obvious, finds the best regression algorithm, reduces the explanatory variables to the important ones in one or more ways, and tunes the parameters of the regression algorithm to the optimal values. Example techniques for reducing explanatory variables include dimensionality reduction, principal component analysis (PCA), and feature engineering. In the system disclosed herein, non-numeric information, such as patent classification code, are used for predicting the patent value. Conventional methods do not use the detailed information on the technical field. In addition, the IPC and numerical correspondence table are established based on the feature importance level extracted by feature engineering, and the IPC is converted into numerical values using this table as input data.

FIG. 5 is a flow diagram of an example process 500 for patent valuation using the system 100, according to some implementations. Components of the system 500 are implemented by the modules described above in reference to FIG. 3, according to some implementations. The example in FIG. 5 shows a multi-step process, according to some implementations. The process includes a first step 502 for data preparation, a second step 520 for creating machine learning models, a third step 550 for selecting a machine learning model, and a subsequent step 560 for test data preparation and patent value prediction, according to some implementations. The first step 502 includes extracting training data and validating data, shown as step 506, from an excel file 504 that includes the training data (this training data corresponds to the records 104 in FIG. 1). The extracted training data and validating data are used for creating machine learning models using a plurality of candidate algorithms in the second step 520. In some implementations, the data from the excel file 504 is split into training data and validating data, for example, in a 4:1 ratio. Information 508 extracted by the step 506 is stored on a network or a local hard disk, and includes data for training the machine learning models 102. For example the data includes objective variable 512 for sub-training (e.g., value metrics specified by a user), explanatory variables 514 for sub-training (e.g., patent classification codes in training data), and/or explanatory variables 516 for verification (e.g., patent classification codes in test or validation data), and/or objective variable 518 (e.g., value metric) for verifications, which is the same type of data as the objective variable 512. The objective variable 512 and the explanatory variables 514 from the information 508 are used to train one or more machine learning models (e.g., Light GBM regression 522, Random Forest Regression 524, Support Vector Regression 526, Linear Regression 528, or Other Regression Algorithms 530). The trained machine learning models and the explanatory variables 516 are used to produce respective prediction outputs (e.g., result 532, 534, 536, 538, and 540). In some implementations, in the third step 550, the system 100 evaluates (552) performance of the models 522, 524, 526, 528, 530, by comparing the respective prediction outputs and the objective variable 518 for verifications and measuring the prediction accuracy of the models based on, for example, the degree of an AUC value. Additionally, in the third step 550, the system selects (554) a machine learning model 568, based on the results of the performance evaluation (552), for future patent valuation. FIG. 5 also shows patent classification codes stored in a PKL file 556 (a file created by pickle, a Python module that enables objects to be serialized to files on disk and deserialized back into the program at runtime). The patent classification codes include classification codes that have been used for training a machine learning model. The order of the patent classification codes in the PKL file 556 matches that of the patent classification codes in the training data. FIG. 5 also shows the selected machine learning model stored in another PKL file 558. In some implementations, the patent classification codes that have been used for training and the selected machine learning model may be stored using a single file format. In step 560, the system 100 extracts (562) patent files (e.g., patents stored in an excel file format), extracts (564) test data from the patent files using the patent classification codes 556, and transforms the extracted test data into a large sparse matrix with reference to the column information in the PKL file 556 to generate (566) explanatory variables (e.g., patent classification codes referenced in the input patent) for verification (sometimes referred to as input vector or test vector). The explanatory variables are input to the learning model selected in step 554, to predict (568) a value 570 for the objective variable, which is the same type of data as the objective variable 512, for each patent of the test data (sometimes called prediction result or predicted output). In some implementations, the explanatory variables may be input to the learning model read from the PKL file 558 to predict (568) the value 570. The set of stored PKL files 556 and 558 allows us to predict the value 570 for the object variable without retraining a machine learning model. In this way, the system 100 can be used to predict value of patents according to their patent classification codes, using efficient machine learning techniques (e.g., sparse matrix techniques).

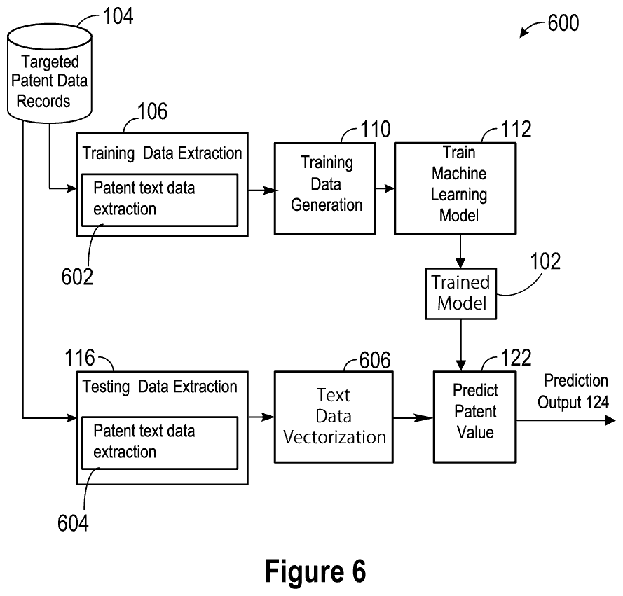

FIG. 6 is a diagram of a system 600 for patent valuation using machine learning when patent classification codes have not been assigned to patents (e.g., unpublished patents), in accordance with some implementations. The system 600 is similar to the system 100 described above in reference to FIG. 1. For the sake of brevity, only the new blocks are described herein. Neither the number of citations nor patentability scores are reliable indicators of the value of recently filed patents because the number or score requires a certain amount of time to become stable. When patent classification codes are not assigned to patents (e.g., unpublished patents), it is possible to vectorize text data in patent documents using natural language processing to use as input data for machine learning. Similar to the system 100, the system 600 can be used for patent valuation using machine learning. The system includes targeted patent data records 104 for storing patents used for training, testing, and/or validation of one or more machine learning models. The system also includes a training data extraction module 106 for extracting data for training a machine learning model from the targeted patent data records. The extracted data includes one or more objective variables to predict value of patents. The system also includes a patent text data extraction module 602 for extracting text data (e.g., text strings) contained in patent documents. The system also includes a training data generation module 110 for generating training data for training one or more machine learning models. The module forms training vectors by converting the text data into a vector using natural language processing (e.g., BERT). The system also includes a module 112 to train one or more machine learning models using the training data generated by the training data generation module. The system also includes a test data extraction module 116, which extracts test data from the targeted patent data records. The system also includes a patent text data extraction module 604, which extracts text data from patent documents in the test data extracted by the test data extraction module. The system also includes a test vector generation module for generating test vectors based on the text data extracted by the patent text data extraction module. The system also includes a module 122 or predicting and/or outputting a value metric (prediction output) for a patent using the text vectors 606 according to a trained machine learning model 102.

In some implementations, the machine learning algorithms include LightGBM regression, Random Forest Regression, Support Vector Regression, Linear Regression, neural networks, deep learning, and/or other regression algorithms. Various methods may be used for vectorization of text data, such as a method for vectorizing sentences based on the number of occurrences of words (e.g., tf-idf, or LSI), a method for using distributed representation of words (e.g., Word2Vec, VMD, or LC-RWMD), or a method for using distributed representation of documents (e.g., Dec2Vec, or Sent2Vec). BERT (Bidirectional Encoder Representations from Transformers) may also be adopted. For BERT, the training data generation module first uses a tokenizer (e.g., SentencePiece, or WordPiece) to split a text string into multiple units called “tokens.” The tokens include not only words but also some symbols, such as [CLS] for the beginning of the tokens and [SEP] for the end of them. Then, the module creates a 512-dimensional vector with numerical data assigned for each token. This vector is then passed to a “Transformer Encoder” to create a 768-dimensional vector. In one example, the input data has 512 tokens and the output vector data has 768 dimensions, but various implementations may use any other combinations of the number of tokens and the number of dimensions. Various implementations employ vectorization methods, other than BERT, which take text data as input and convert it into numerical values.

In another aspect, a method is provided for training a machine learning model for patent valuation. The method includes obtaining a list of patent applications (includes at least one of issued patents and unissued patent applications) for training the machine learning model. For each of a plurality of patents applications in the list of patent applications, the method includes: (i) vectorizing a respective data set of text strings for the respective patent application into a training vector consisting of m dimensions using natural language processing. The ith element in the training vector is a numerical value representing one of m distinct textual features (e.g., a token, a word, or a phrase) of the text strings; and (ii) receiving a respective user-specified value metric for the respective patent application. The method also includes generating a training data table comprising the training vectors. The same ith elements out of multiple training vectors of the patent applications in the training data table are possible to be numerical values that are generated based on different tokens for each row since the training vectors are created after splitting text strings into multiple different sets of tokens depending on the patent documents. The method also includes training a machine learning model according to the training data table. The machine learning model is configured to predict value metrics for patent applications according to the numerical values of textual features.

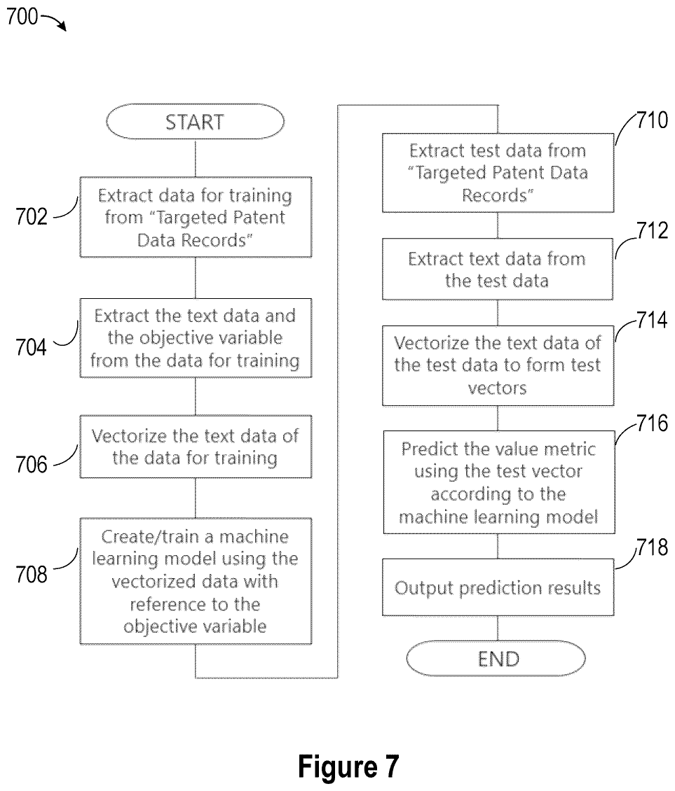

FIG. 7 shows a flowchart of a method 700 for training a machine learning model for patent valuation, according to some implementations. The method includes extracting (702) data for training from Targeted Patent Data Records, extracting (704) the text data and objective variable (e.g., patent application value) from the data for training, vectorizing (706) the text data of the data for training, creating/training (708) a machine learning model using the vectorized data with reference to the objective variable, extracting (710) test data from the Targeted Patent Data Records, extracting (712) text data from the test data, vectorizing (714) the text data of the test data to form test vectors, predicting (716) the value metric using the test vector according to the machine learning model, and outputting (718) the prediction results.

In another aspect, a method is provided for using machine learning for patent valuation. The method includes obtaining a patent document (which may be an issued patent or an unissued patent application) that requires valuation. The method also includes obtaining a set of one or more text strings for the patent application. The method also includes vectorizing a respective data set of the text strings into an input vector consisting of m dimensions using natural language processing. The ith element in the training vector is a numerical value representing one of m distinct textual features (e.g., a token, a word, or a phrase) of the text strings. The method also includes predicting and outputting a value metric for the patent according to a trained machine learning model that has been trained to predict value metrics for patents according to numerical values of textual features and user-supplied value metrics.

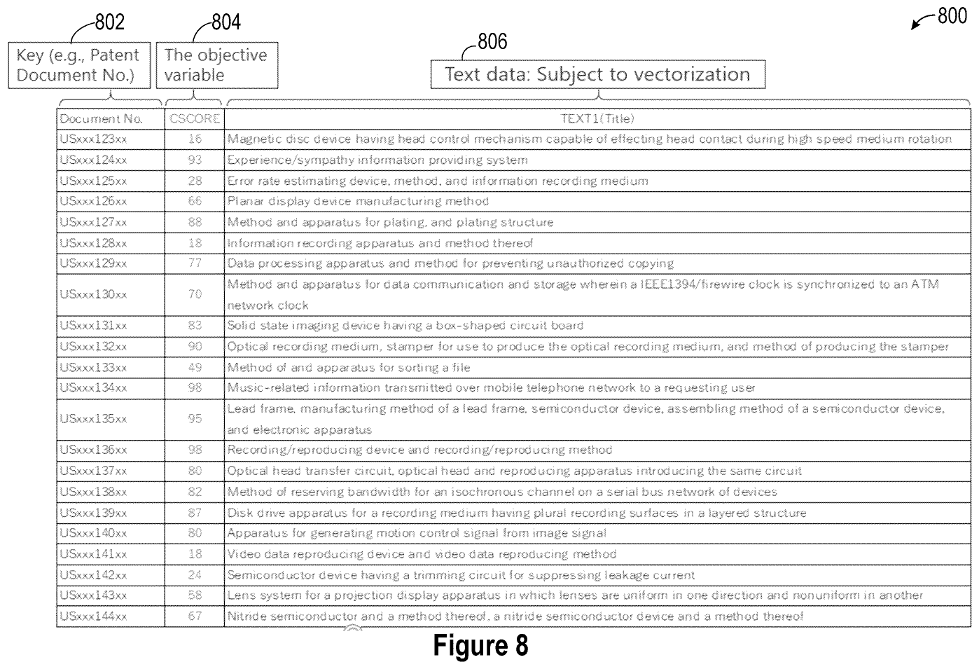

FIG. 8 shows an example input data table 800, according to some implementations. The input data for training a learning model include at least the objective variable and text data (text strings). In some implementations, the table includes a first column 802 for keys (e.g., patent document numbers), a second column 804 for an objective variable (e.g., citation scores), and additional columns 806 for text data that can be vectorized. In some implementations, if text data cannot be extracted from the Targeted patent data records, a text string indicating that text data could not be obtained may be filled out in the third column 806 (e.g., blank).

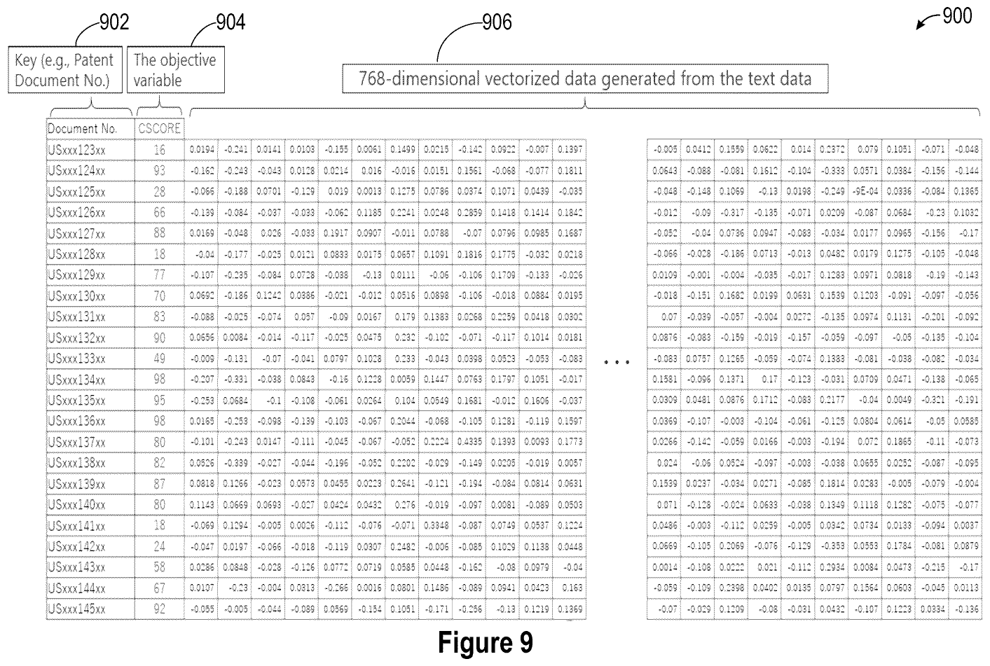

FIG. 9 shows an example vectorized data table 900 for the example input data table 800, according to some implementations. Some implementations vectorize the text data (text strings) and input the training vectors into a machine learning algorithm (e.g., LightGBM regression). In some implementations, the table includes a first column 902 for keys (e.g., patent document number), a second column 904 for an objective variable (e.g., a citation score), and columns 906 for vectorized data generated from the text data.

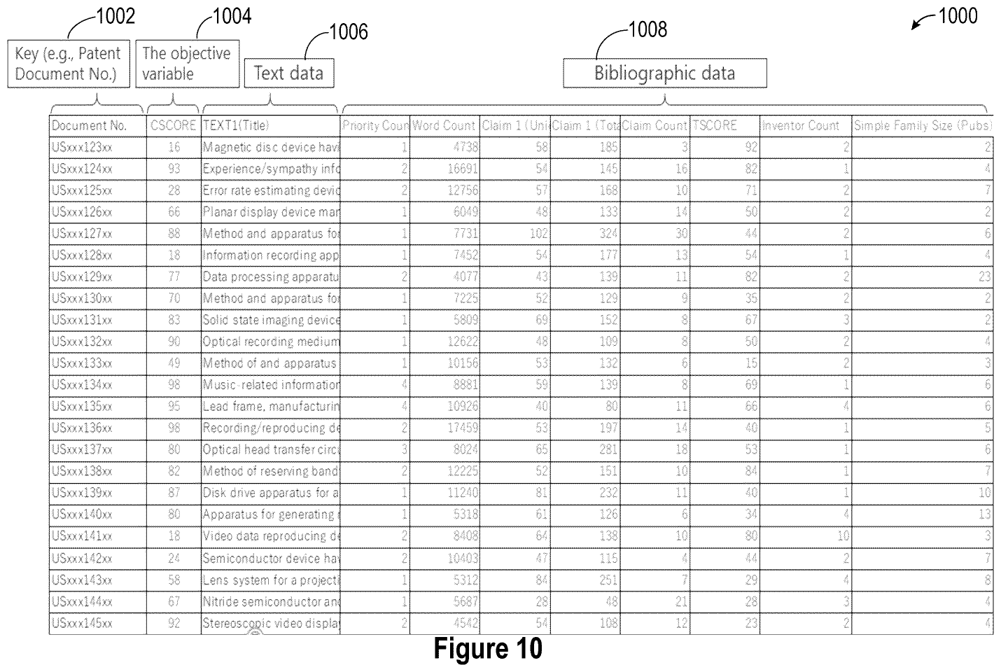

FIG. 10 shows an example input data table 1000, according to some implementations. In some implementations, the table includes a first column 1002 for keys (e.g., patent document numbers), a second column 1004 for an objective variable (e.g., citation scores), a third column 1006 for text data (e.g., the titles of patent applications), and columns 1008 for bibliographic data (e.g., priority count, word count, unique words in claim 1, total words in claim 1, claim count, TSCORE, inventor count, and family size (publications)). The data for training a learning model may include bibliographic data in addition to the objective variable and text data.

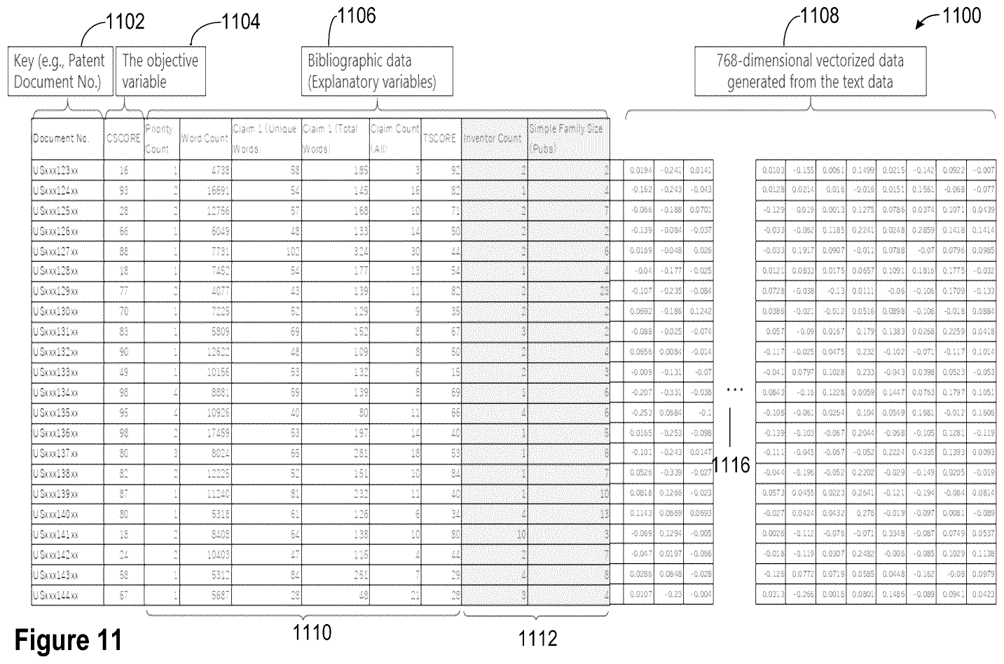

FIG. 11 shows an example vectorized data table 1100 for the example input data table 1000, according to some implementations. Some implementations vectorize text data and merge with bibliographic data to generate training vectors, and input them into a machine learning algorithm. In some implementations, the table includes a first column 1102 for keys (e.g., patent document numbers), a second column 1104 for an objective variable (e.g., citation scores), and columns 1106 for bibliographic data (e.g., explanatory variables, priority count, word count, unique words in claim 1, total words in claim 1, claim count, TSCORE, inventor count, and family size (publications)). A first subset 1110 of the columns 1106 may be obtained from a patent database, or calculated based on specifications or claims. A second subset 1112 of the columns 1106 may be obtained from a patent database.

Additional columns 1108 may include vectorized data generated from the text data (e.g., 512 dimensions or 768 dimensions). Columns to the right of label 1114 are added and values are updated. Note that the “ . . . ” symbol drawn in FIG. 9 are columns omitted because there are 768 columns after vectorizing and so they cannot be described.

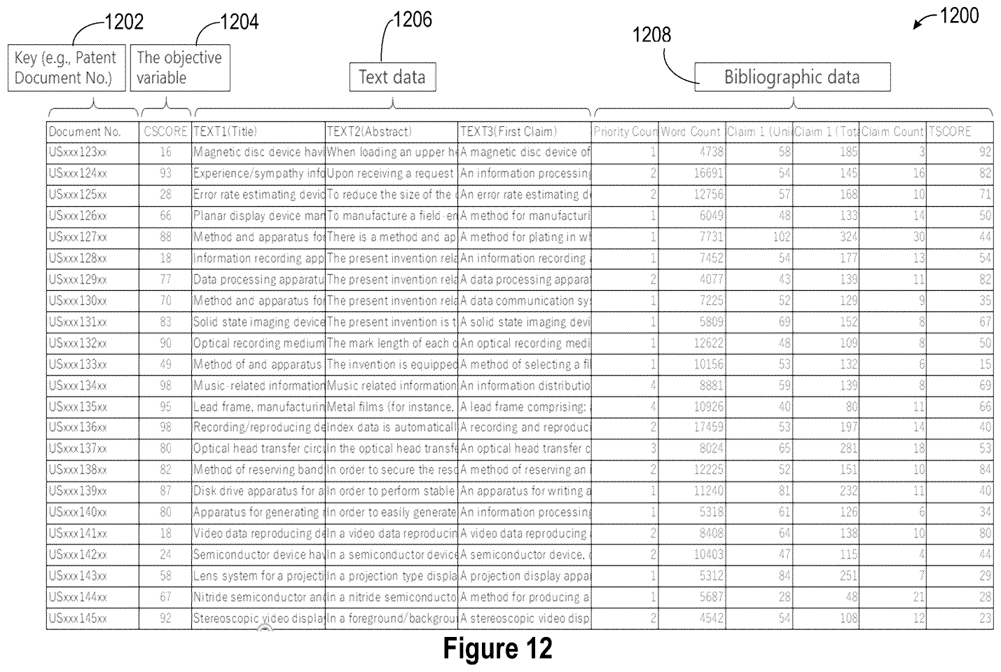

FIG. 12 shows an example input data table 1200, according to some implementations. In some implementations, the table includes a first column 1202 for keys (e.g., patent document numbers), a second column 1204 for an objective variable (e.g., citation scores), columns 1206 for text data (e.g., titles of patent applications, abstracts, and first claims), and columns 1208 for bibliographic data (e.g., priority count, word count, unique words in claim 1, total words in claim 1, claim count, and TSCORE). In some implementations, the data for training a learning model includes multiple sets of text data (e.g., titles, abstracts, claims, and/or embodiments).

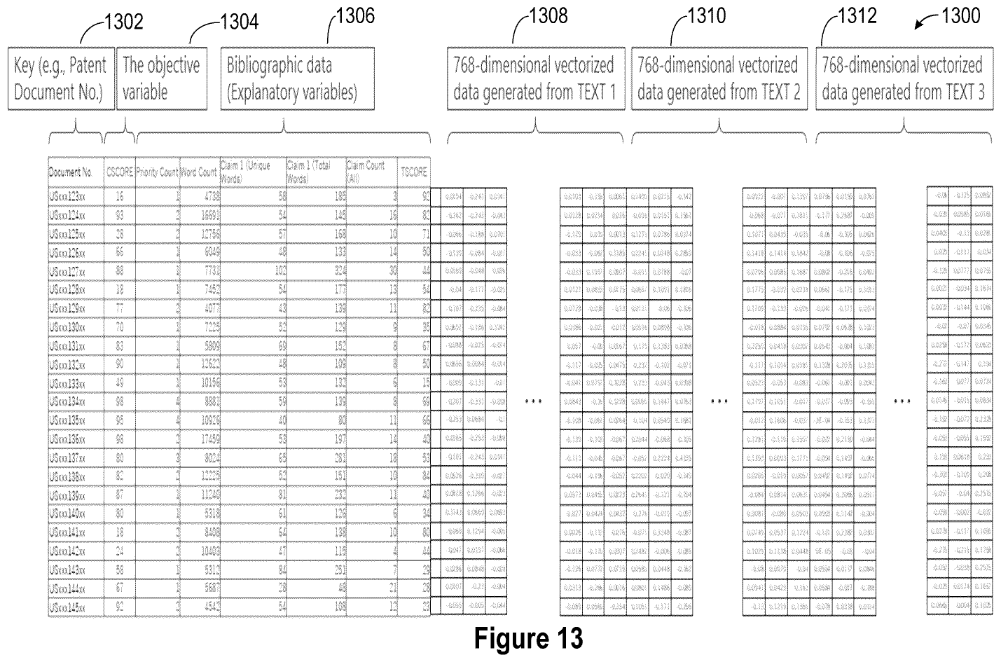

FIG. 13 shows an example vectorized data table 1300 for the example input data table 1200, according to some implementations. Some implementations vectorize multiple sets of text data and merge with bibliographic data to generate training vectors. These vectors are input into a machine learning algorithm (e.g., LightGBM regression). In some implementations, the table includes a first column 1302 for keys (e.g., patent document numbers), a second column 1304 for an objective variable (e.g., citation scores), and columns 1306 for bibliographic data (e.g., explanatory variables, such as priority count, word count, unique words in claim 1, total words in claim 1, claim count, and TSCORE). In some implementations, additional columns 1308 include 768-dimensional vectorized data generated from first text. In some implementations, additional columns 1310 include 768-dimensional vectorized data generated from second text. In some implementations, additional columns 1312 include 768-dimensional vectorized data generated from third text.

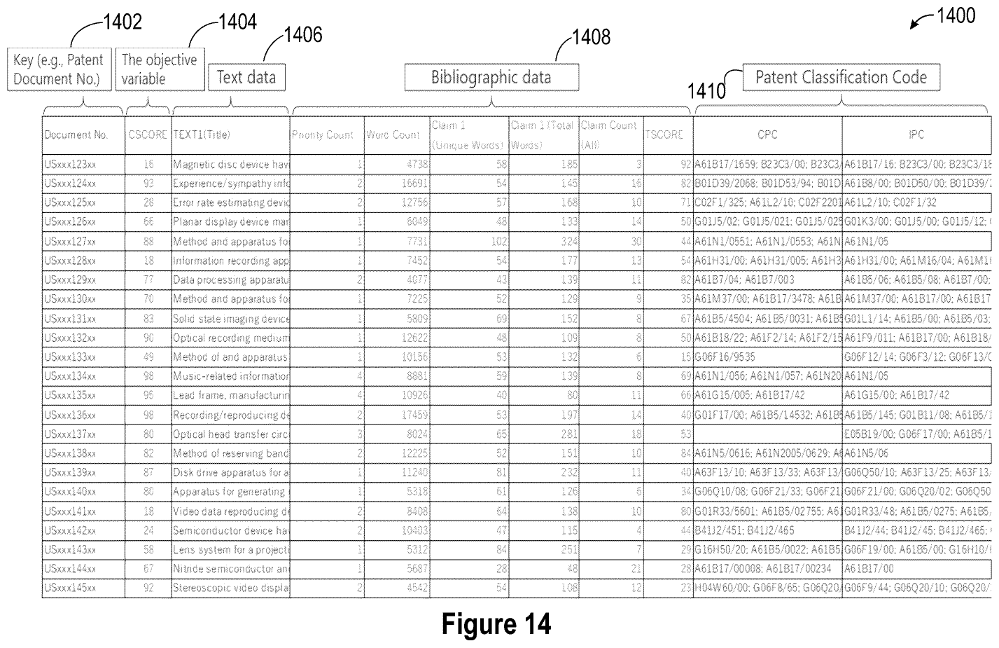

FIG. 14 shows an example input data table 1400, according to some implementations. In some implementations, the table includes a first column 1402 for keys (e.g., patent document numbers), a second column 1404 for an objective variable (e.g., citation scores), a third column 1406 for text data (e.g., the titles of the patent applications), columns 1408 for bibliographic data (e.g., priority count, word count, unique words in claim 1, total words in claim 1, claim count, and TSCORE), and columns 1410 for patent classification codes (e.g., CPC or IPC codes). The data for training a learning model may include bibliographic data and patent classification codes in addition to the objective variable and text data.

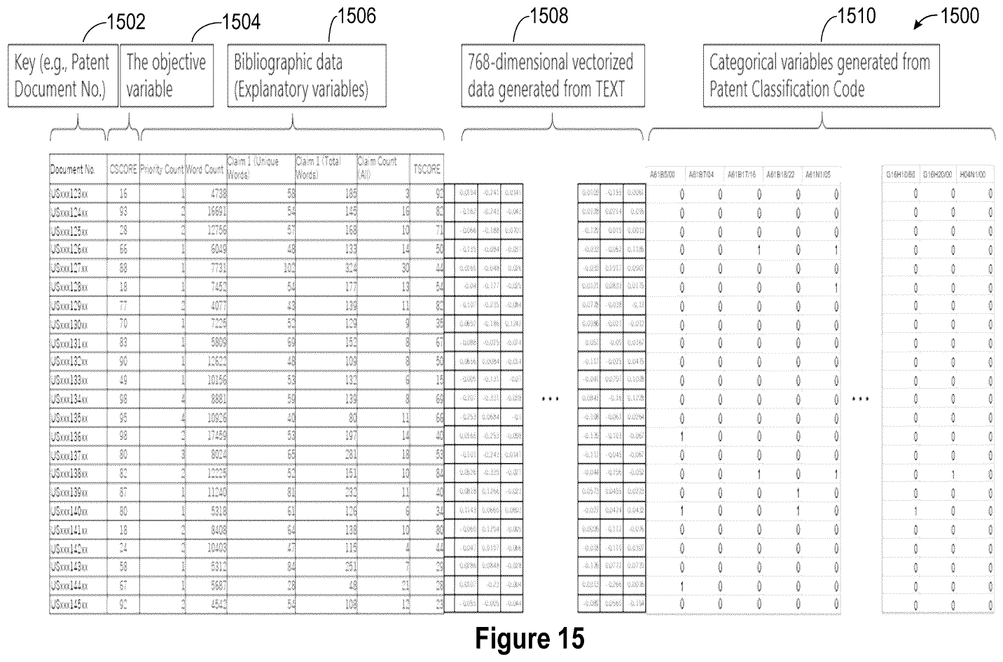

FIG. 15 shows an example vectorized data table 1500 for the example input data table 1400, according to some implementations. Some implementations vectorize text data, convert patent classification codes into categorical variables, and merge with bibliographic data to generate training vectors. These vectors are input into a machine learning algorithm (e.g., LightGBM regression). In some implementations, the table includes a first column 1502 for keys (e.g., patent document numbers), a second column 1504 for an objective variable (e.g., citation scores), columns 1506 for bibliographic data (e.g., explanatory variables, such as priority count, word count, unique words in claim 1, total words in claim 1, claim count, and TSCORE). In some implementations, additional columns 1508 include 768-dimensional vectorized data generated from text (e.g., the text column 1406 in FIG. 14), and additional columns 1510 include categorical variables generated from patent classification codes.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

According to 17th aspect, a method for training a machine learning model for patent valuation, the method comprising:
obtaining a list of patent applications for training the machine learning model;
for each of a plurality of patent applications in the list of patent applications:
   vectorizing a respective set of text strings for the respective patent application to form a training vector consisting of m dimensions using natural language processing, wherein each element in the training vector is a numerical value representing one of m distinct textual features of the text strings; and
   receiving a respective user-specified value metric for the respective patent;
   generating a training data table comprising the training vectors; and
   training the machine learning model according to the training data table, the machine learning model configured to predict value metrics for patent applications according to the numerical values of textual features.

According to 18th aspect, the method according to 17th aspect, further comprising for each of the plurality of patent applications:
extracting additional information from the respective patent application, wherein the additional information includes numeric data and non-numeric data;
converting the non-numeric data in the respective patent to categorical variables; and
generating the training data table further based on the numeric data and the categorical variables.

According to 19th aspect, the method according to 18th aspect, wherein the additional information includes classification codes used by a patent office to search for prior art related to the respective patent application.

According to 20th aspect, the method according to 18th aspect, wherein the additional information includes bibliographic data for the respective patent application.

According to 21th aspect, the method of any of 17th to 20th aspect, further comprising:
after training the machine learning model:
   obtaining a new patent application;
   vectorizing a respective set of text strings for the new patent application to form a training vector consisting of m dimensions using natural language processing, wherein each element in the training vector is a numerical value representing one of m distinct textual features of the text strings;
   receiving a new user-specified value metric for the new patent application;
   updating the training data table to include the training vector; and
   retraining the machine learning model according to the updated training data table.

According to 22th aspect, the method of any of 17th to 20th aspect, wherein the machine learning model includes one or more models selected from the group consisting of:
(i) Support Vector Regression;
(ii) Light Gradient Boosted Machine regression;
(iii) Random forest regression;
(iv) Binary or multi-valued classifiers; and
(v) Deep neural networks.

According to 23th aspect, a method for using machine learning for patent valuation, the method comprising:
obtaining a patent application that requires valuation;
obtaining a set of text strings for the patent application;
vectorizing the set of the text strings for the patent application into an input vector consisting of m dimensions using natural language processing, wherein each element in the input vector is a numerical value representing one of m distinct textual features of the text strings; and
predicting and outputting a value metric for the patent application according to a trained machine learning model that has been trained to predict value metrics for patent applications according to numerical values of textual features and user-supplied value metrics.

According to 24th aspect, the method of 23th aspect, further comprising:
extracting additional information from the patent application, wherein the additional information includes numeric data and non-numeric data;
wherein forming the input vector further comprises converting the non-numeric data in the patent application to categorical variables, and including the numeric data and the categorical variables in the input vector.

According to 25th aspect, the method of any of 24th aspect, wherein the additional information includes classification codes used by the patent office to search for prior art related to the patent application.

According to 26th aspect, the method of any of 24th aspect, wherein the additional information includes bibliographic data for the patent application.

According to 27th aspect, the method of any of 23th to 26th aspect, wherein the trained machine learning model includes one or more models selected from the group consisting of:
(i) Support Vector Regression;
(ii) Light Gradient Boosted Machine regression;
(iii) Random forest regression;
(iv) Binary or multi-valued classifiers; and
(v) Deep neural networks.

According to 28th aspect, a system for patent valuation using machine learning, the system comprising:
a database storing targeted patent data records used for training, testing, and/or validation of one or more machine learning models;
a training data extraction module for extracting data for training a machine learning model from the targeted patent data records, wherein the extracted data includes one or more objective variables to predict value of patent applications;
a patent text data extraction module for extracting text data contained in documents for patent applications;
a training data generation module for generating training data for training one or more machine learning models, wherein the training data generation module forms training vectors by converting the text data into a vector using natural language processing;
a module to train one or more machine learning models using the training data generated by the training data generation module;
a test data extraction module, which extracts test data from the targeted patent data records;
a patent text data extraction module, which extracts text data from patent applications in the test data extracted by the test data extraction module;
a test vector generation module for generating test vectors based on the text data extracted by the patent text data extraction module; and
a module for predicting and outputting a value metric for a patent application using the test vectors according to a trained machine learning model.

What is claimed is:

1. A method for training a machine learning model for patent valuation, the method comprising:
obtaining an ordered master list of n distinct patent classification codes c₁, c₂, . . . , cₙ used by a patent office to characterize patent subject matter;
for each of a plurality of patents issued by the patent office:
obtaining a respective set of one or more patent classification codes assigned to the respective patent by the patent office, wherein each of the patent classification codes in the respective set matches a respective patent classification code in the master list;
forming a respective training vector comprising n elements, wherein the ith element in the respective training vector is a categorical variable that specifies whether the patent classification code c₁ is included in the respective set of one or more classification codes; and
receiving a respective user-specified value metric for the respective patent;
generating a training data table comprising the training vectors; and
training a machine learning model according to the training data table, the machine learning model configured to predict value metrics for patents according to their corresponding patent classification codes.

2. The method according to claim 1, further comprising for each of the plurality of patents issued by the patent office:
extracting additional information from the respective patent, wherein the additional information includes numeric data and non-numeric data;
converting the non-numeric data in the respective patent to additional categorical variables; and
generating the training data table further based on the numeric data and the additional categorical variables.

3. The method according to claim 1, wherein the additional information includes classification codes used by the patent office to search for prior art related to the respective patent.

4. The method according to claim 1, further comprising:
storing the machine learning model along with the master list of patent classifications.

5. The method according to claim 4, further comprising:
compressing, column-wise, the machine learning model and the master list of patent classifications.

6. The method according to claim 1, further comprising:
after training the machine learning model:
obtaining a new patent issued by the patent office;
obtaining a new set of one or more patent classification codes assigned to the new patent by the patent office, wherein at least one patent classification code cₙ₊₁ in the new set does not match any patent classification code in the master list;
updating each training vector in the training data table to include another element corresponding to the at least one patent classification code cₙ₊₁;
updating the training data table to include a new training vector comprising n+1 elements for the new patent, wherein the ith element in the new training vector is a categorical variable that specifies whether the patent classification code c₁ is included in the new set of one or more classification codes; and
retraining the machine learning model according to the updated training data table.

7. The method according to claim 1, wherein the machine learning model is further configured to output a respective confidence level for each predicted value metric, wherein the respective confidence value for a respective patent is based on a percentage of patent classification codes for the respective patent that are included in the training data table.

8. The method according to claim 7, further comprising:
in accordance with a determination that the respective confidence level is below a minimum confidence level threshold:
obtaining a new patent issued by the patent office;
obtaining a new set of one or more patent classification codes assigned to the new patent by the patent office, wherein at least one patent classification code cₙ₊₁ in the new set does not match any patent classification codes in the master list;
extending the master list to incorporate the one or more patent classification codes assigned to the new patent, include the at least one patent classification code cₙ₊₁;
updating each training vector in the training data table to include another element corresponding to the at least one patent classification code cₙ₊₁;
updating the training data table to include a new training vector comprising n+1 elements for the new patent, wherein the ith element in the new training vector is a categorical variable that specifies whether the patent classification code c₁ is included in the new set of one or more classification codes; and
retraining the machine learning model according to the updated training data table.

9. The method according to claim 1, wherein the machine learning model includes one or more models selected from the group consisting of:
Support Vector Regression;
(ii) Light Gradient Boosted Machine regression;
(iii) Random forest regression;
(iv) Binary or multi-valued classifiers; and
(v) Deep neural networks.

10. The method according to claim 1, wherein the master list of patent classification codes is extracted from the plurality of patents.

11. A method of using machine learning for patent valuation, the method comprising:
obtaining an ordered master list of n distinct patent classification codes c₁, c₂, . . . , cₙ used by a patent office to characterize patent subject matter;
obtaining a patent that requires valuation;
obtaining a set of one or more patent classification codes for the patent, wherein one or more of the patent classification codes in the set match a respective patent classification code in the master list;
forming an input vector comprising n elements, wherein the ith element in the input vector is a categorical variable that specifies whether the patent classification code cᵢ is included in the set of one or more classification codes; and
predicting and outputting a value metric for the patent according to a trained machine learning model that has been trained to predict value metrics for patents according to their respective patent classification codes and user-supplied value metrics.

12. The method according to claim 11, further comprising:
extracting additional information from the patent, wherein the additional information includes numeric data and non-numeric data;
wherein forming the input vector further comprises converting the non-numeric data in the patent to additional categorical variables, and including the numeric data and the additional categorical variables in the input vector.

13. The method according to claim 11, the method further comprising:
in accordance with a determination that the patent corresponds to an unpublished patent that lacks patent classification codes:
estimating the set of one or more patent classification codes for the patent based on one or more attributes of the patent selected from the group consisting of:
inventor information;
(ii) applicant information; and
(iii) subsidiary information.

14. The method according to claim 11, wherein the trained machine learning model includes one or more models selected from the group consisting of:
Support Vector Regression;
(ii) Light Gradient Boosted Machine regression;
(iii) Random forest regression;
(iv) Binary or multi-valued classifiers; and
(v) Deep neural networks.

15. The method according to claim 11, wherein the master list of patent classifications and the trained machine learning model are compressed and stored in a compressed file, the method further comprising:
decompressing the compressed file to retrieve the trained machine learning model and the master list of patent classifications.

16. The method according to claim 11, wherein the master list of patent classifications and the trained machine learning model are serialized into one or more byte streams, the method further comprising:
deserializing the one or more byte streams to retrieve the master list of patent classifications and the trained machine learning model.

17. A method for training a machine learning model for patent valuation, the method comprising:
obtaining a list of patent applications for training the machine learning model;
for each of a plurality of patent applications in the list of patent applications:
vectorizing a respective set of text strings for the respective patent application to form a training vector consisting of m dimensions using natural language processing, wherein each element in the training vector is a numerical value representing one of m distinct textual features of the text strings; and
receiving a respective user-specified value metric for the respective patent;
generating a training data table comprising the training vectors; and
training the machine learning model according to the training data table, the machine learning model configured to predict value metrics for patent applications according to the numerical values of textual features.

18. The method according to claim 17, further comprising for each of the plurality of patent applications:
extracting additional information from the respective patent application, wherein the additional information includes numeric data and non-numeric data;
converting the non-numeric data in the respective patent to categorical variables; and
generating the training data table further based on the numeric data and the categorical variables.

19. The method according to claim 18, wherein the additional information includes classification codes used by a patent office to search for prior art related to the respective patent application.

20. The method according to claim 18, wherein the additional information includes bibliographic data for the respective patent application.
